(19) United States
(12) Patent Application Publication
(10) Pub. No.: US 2022/0104480 A1
(43) Pub. Date: Apr. 7, 2022

(54) TWO-DIMENSIONAL DECOY

(71) Applicant: JR SIGN COMPANY INC., Prophetstown, IL (US)

(72) Inventors: Michael Scott BIELEMA, Dunlap, IL (US); Roger L. Williams, JR., Prophetstown, IL (US)

(73) Assignee: JR SIGN COMPANY INC., Prophetstown, IL (US)

(21) Appl. No.: 17/493,489

(22) Filed: Oct. 4, 2021

Related U.S. Application Data
(60) Provisional application No. 63/086,672, filed on Oct. 2, 2020.

(51) Int. Cl. A01M 31/06

(52) U.S. Cl. CPC A01M 31/06

(57) ABSTRACT

A bird decoy apparatus includes a first piece with a blank resembling a like size and shape of a first profile of a bird. A second piece includes a blank resembling a like size and shape of a second profile of the bird. At least one removable support is inserted into the first piece. The second piece is inserted to the first piece at a series of slots to assemble the bird decoy.

### CROSS REFERENCE TO RELATED APPLICATION(S)

This application claims the benefit of U.S. Provisional Application Ser. No. 63/086,672, filed on 2 Oct. 2020. The co-pending provisional application is hereby incorporated by reference herein in its entirety and is made a part hereof, including but not limited to those portions which specifically appear hereinafter.

### BACKGROUND OF THE INVENTION

This invention relates generally to a two-dimensional decoy and, more particularly, to a bird decoy that can be easily dismantled for compact storage.

There are many types of bird decoys. Current decoys often include three-dimensional structures that resemble a realistic size and shape of various bird species. Such decoys may be constructed from various materials such as molded plastic or foam. The decoys can be placed in various settings such as staked into the ground or freestanding. Some decoys may also be manufactured so that they may float atop water.

Generally, bird decoys are used to attract actual birds to the locations of the decoys. They are most commonly used to attract birds for bird watching or hunting purposes. Certain decoys may also be used to deter certain bird species by resembling or attracting predators. Therefore, bird decoys can often be found in a wide variety of bird species such as various types of ducks, geese and swans.

However, such decoys often present problems of being large and bulky, without an efficient way of storing them when not in use. Due to the nature of the decoys, they often also prove inefficient in luring birds from far distances. The birds will often only notice the decoys and approach if the birds are close to the ground, or already on the ground. As such, a higher quantity of decoys may be used, but this then continues to present issues of storage and inefficiency. Therefore, a need exists for improved bird decoys that are improved for storage capabilities as well as to increase success in luring actual birds.

### SUMMARY OF THE INVENTION

A general object of the invention can be attained, at least in part, through a bird decoy apparatus. The bird decoy apparatus includes a first piece that includes a blank of like size and shape of a first profile of a bird. The bird decoy apparatus also includes a second piece that includes a blank of like size and shape of a second profile of the bird. The bird decoy apparatus also includes at least one removable support at least partially inserted into the first piece.

The first profile of the bird includes a side view of a body of a bird. The second profile of the bird includes a top view of a body of a bird. The top view includes wings of the body of the bird.

The blank of the first piece includes a head portion, a tail portion, and an edge side surrounding a surface area of the first piece. The first piece may also include a slot at the tail portion of the first piece. The slot extends horizontally from the tail portion of the first piece. The edge side may be corrugated. The corrugated edge side of the first piece can hold the at least one removable support.

The first piece may also include a first side and a second side. The corrugated edge side is disposed therebetween the first side and the second side. The first side may include a photo of the side view of a body of a bird. The second side mirrors the first side.

The blank of the second piece includes a right wing portion, a left wing portion, and an edge side surrounding a surface area of the second piece. The right wing portion and the left wing portion extend from a head end of the second piece to a tail end of the second piece. The edge side can be corrugated. The second piece can also include a slot at the head end of the second piece. The slot extends horizontally between the right wing portion and the left wing portion, from the head end of the second piece.

The second piece also includes a first side and a second side. The corrugated edge side is disposed therebetween the first side and the second side. The first side may include a photo of the top view of a body of a bird. The second side mirrors the first side.

The slot of the first piece can accept the second piece at the horizontal slot of the second piece. The second piece can be arranged perpendicular to the first piece. The second piece can also be arranged parallel to the first piece.

Other objects and advantages will be apparent to those skilled in the art from the following detailed description taken in conjunction with the appended claims and drawings.

### BRIEF DESCRIPTION OF THE DRAWINGS

FIG. 1 is a side view of a bird decoy apparatus according to one embodiment of the invention;

FIG. 2 is a side perspective view of the bird decoy apparatus, opposite the side view of FIG. 1, according to the embodiment of FIG. 1;

FIG. 3 is a side view of a bird decoy apparatus according to one embodiment of the invention;

FIG. 4A is a top view of a second piece of the bird decoy apparatus in a disassembled state according to the embodiment of FIG. 1;

FIG. 4B is a top view of a first piece the bird decoy apparatus in a disassembled state according to the embodiment of FIG. 1;

FIG. 5 is a top view of the bird decoy apparatus in an assembled state according to the embodiment of FIG. 1;

FIG. 6 is a perspective side view of the bird decoy apparatus in a folded state according to the embodiment of FIG. 1; and

FIG. 7 is a perspective view of several bird decoys in a folded, disassembled state for storage according to the embodiment of FIG. 1.

### DETAILED DESCRIPTION OF THE INVENTION

The invention generally relates to provide an improved bird decoy that is generally two-dimensional when disassembled. The general object of the invention can be attained, at least in part, through a bird decoy apparatus that includes a first piece and a second piece. The first piece includes a vertical portion of a bird body. The second piece includes a horizontal portion of a bird body. The second piece may be connected to the first piece. The apparatus also includes a removable support that can be inserted into the first piece.

As used herein, references to waterfowl are to be understood to refer to an order of birds that generally includes ducks, geese and swans. References to sentry are to be understood to refer to a position of a bird decoy generally categorized by a head and neck extending upwards vertically. References to resting are to be understood to refer to a position of a bird decoy generally categorized by a relaxed head and neck. References to feeding are to be understood to refer to a position of a bird decoy generally categorized by a head and neck extending downwards vertically.

The present invention provides a bird decoy apparatus that may lure birds to, or deter birds from, a designated area. The bird decoy apparatus may be manufactured to resemble any number of birds, particularly waterfowl. The bird decoy apparatus may also be manufacture to resemble birds in a variety of positions such as, but not limited to, sentry, resting, and feeding positions

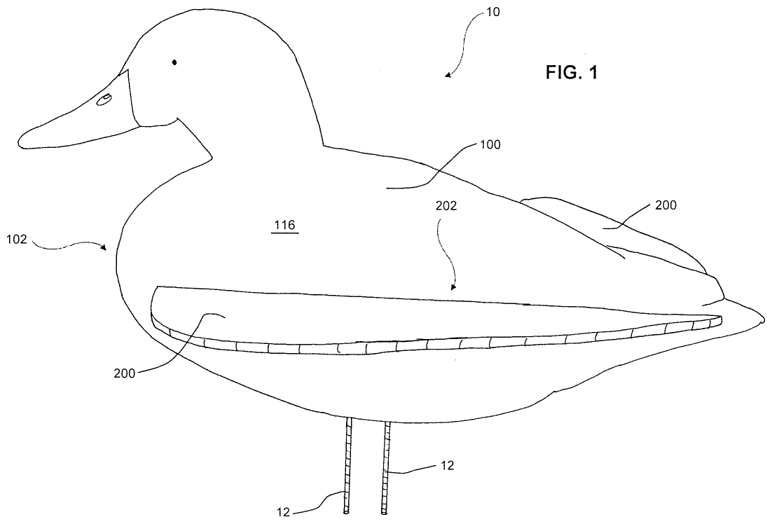

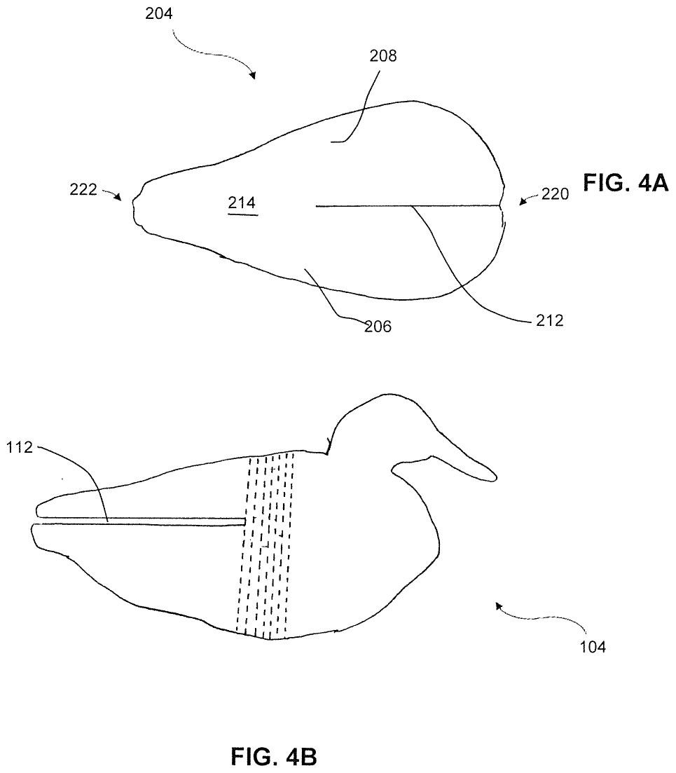

FIG. 1 shows a bird decoy apparatus 10, when assembled. The body of the decoy is generally formed by two pieces (shown disassembled in FIGS. 4A-B). The bird decoy apparatus includes a first piece 100 and a second piece 200.

The first piece 100 is made of a blank 102 that represents the size and shape of a first profile 104 of a waterfowl (such as a Mallard duck in a resting position as shown in FIG. 1). The first piece 100 shows a vertical portion of the body, which is seen as a side-view profile of the duck.

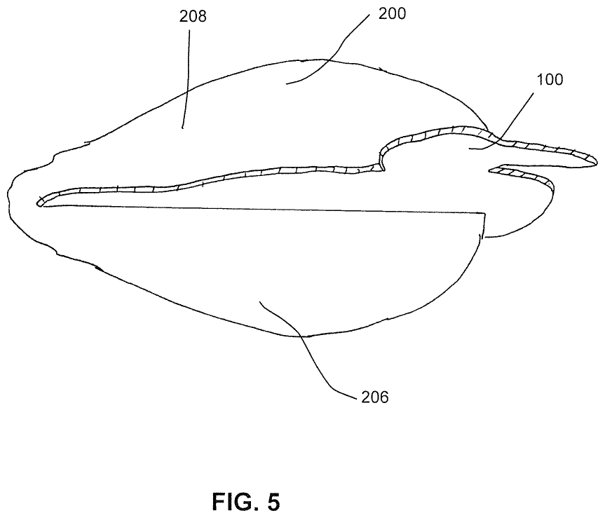

The second piece 200 is made of a blank 202 that represents the size and shape of a second profile 204 of a waterfowl. The second piece 200 shows a horizontal portion of the body, which is seen as a top-view profile of the duck (shown best in FIG. 5). In some embodiments of the invention, the second piece may generally show the wings of the bird.

As shown in FIGS. 1-3, the bird decoy apparatus also includes at least one removable support 12 for anchoring the decoy into the ground. At least one support piece 12 is included that is inserted into the first piece 100 so that the decoy 10 can be inserted into the ground or otherwise displayed. As shown in FIGS. 1-3, the support may be in the form of a stake(s) that can be inserted into the first piece. The stake may be a metal stake or any other suitable material that allows the decoy to be inserted into the ground. In some embodiments more than one stake may be used. In other embodiments the stake may be replaced with an anchor or flotation device so as to allow the decoy to be placed over water or freestanding.

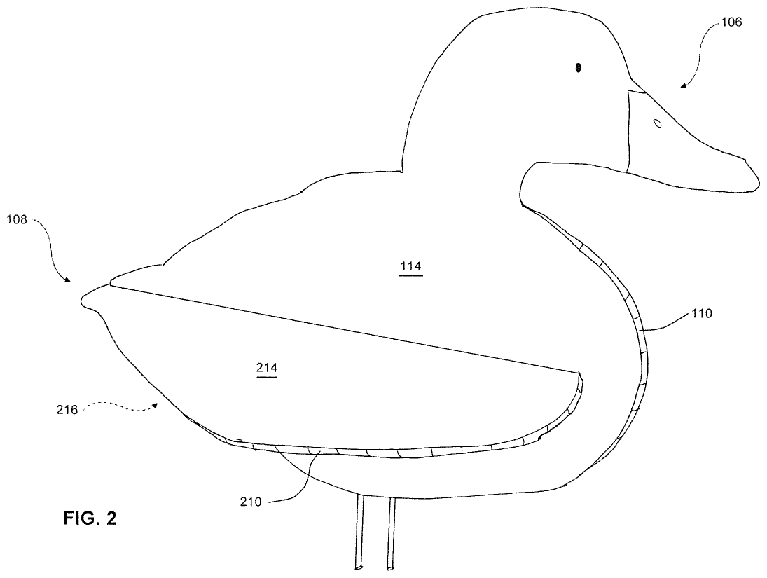

FIG. 2 shows another view of the bird decoy apparatus 10. As shown, the blank of the first piece of the apparatus includes a head portion 106 and a tail portion 108. The first piece also includes an edge side 110 that surrounds a surface area of the first piece. Similarly, the second piece also includes an edge side 210 that surrounds a surface area of the second piece.

The first and second pieces may be manufactured from a variety of materials. In one embodiment of the invention, the first and second pieces are made from corrugated plastic, although other materials may be used. The corrugations form the edge sides 110, 210 and allow for a partially hollow interior of each piece. The at least one removable support 12 used to anchor the decoy may be of like size and shape to the corrugations so that the supports 12 can be easily inserted and removed from the first piece through the desired corrugation placement, without compromising the integrity of the plastic pieces.

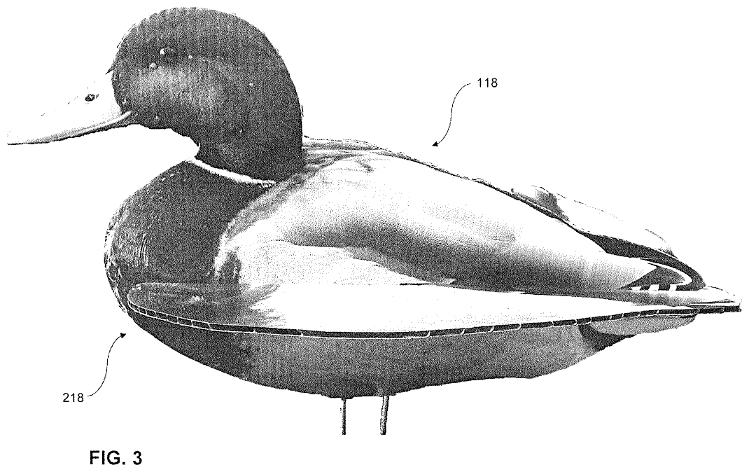

As shown in FIG. 3, the blanks 102, 202 of the first 100 and second pieces 200 of the decoy 10 include a printed image or photo 118, 218 of the desired decoy bird. The image is digitally printed so as to resemble an actual bird. The printed image may be sourced from photographs of live birds, but the image may also be painted, sketched or printed from other various sources.

The printed image is mirrored on both the first and second pieces. That is, both pieces of the decoy can be reversible. The first piece 100 includes a first side 114 (as shown in FIG. 2) that includes a side profile image of a bird 118; and the first piece 100 also includes a second side 116 (as shown in FIG. 1) that includes a mirrored side profile image 118 of the bird. Likewise, the second piece 200 includes a first side 214 (as shown in FIG. 2) that includes a top profile (or wing profile) image 218 of a bird, and the second piece 200 also includes a second side 216 that includes a mirrored top profile image 218 of the bird.

The corrugated edges 110, 210 are essentially sandwiched in between the sides of the respective pieces (between the first 114 and second 116 side of the first piece 110; and between the first 214 and second 216 side of the second piece 200).

This allows a user to choose a more desirable side of each piece when assembling the decoy. This feature may be especially desirable if one side of a piece is damaged from previous use, faded from sun exposure, contains debris, etc. The reversible images allow more continuous uses out of the decoy and the high-quality, real images printed on the decoy provide for actual birds to recognize the decoy from farther distances.

In order for the decoy to be assembled, the first piece additionally includes a slot 112, shown in FIG. 4B. The slot 112 is preferably horizontal and originates at the tail portion 108 of the first profile 104 on the first piece 100 of the decoy. The slot 112 extends approximately to a midpoint of the first piece and is parallel with the ground when the decoy is assembled. The horizontal slot is preferably centered along a midpoint of the bird's body on the first piece. The horizontal slot may include a thickness that approximately matches a thickness of the second piece.

Additionally, the second piece also includes a slot 212, shown in FIG. 4A. This slot 212 is also preferably horizontal and originates at a head end 220 of the second profile 204 on the second piece 200 of the decoy. The slot 212 extends approximately to a midpoint of the second piece, towards a tail end 222 of the second piece. The horizontal slot 212 of the second piece is preferably centered along a midpoint of the second piece between a right wing portion 206 and a left wing portion 208 on the blank. The horizontal slot of the second piece may also include a thickness that approximately matches a thickness of the first piece. In one embodiment of the invention the first piece and the second piece have the same thickness, however the thickness of the pieces may also vary.

To assemble the decoy, the at least one removable support 12 is inserted into the first piece through corrugations on the edge 110 of the first piece (a portion of the corrugations is shown in FIG. 4B). The first piece can then be staked to the ground at a desired location.

As shown in FIG. 5, the second piece 200 can then be inserted into the slot 112 of the first piece 100 from the tail end 222 of the second piece 200. The slot 112 of the first piece 100 engages with the slot 212 of the second piece 200 so that the right 206 and left 208 wing portions of the second piece 200 protrude perpendicularly out from the first piece 100. Once the second piece 200 is fully inserted into the first piece 100, and both horizontal slots are engaged, and the first piece is perpendicular to the second piece, the decoy is fully assembled for use.

When not in use, the decoy may be disassembled by removing the second piece 200 from the first piece 100 and removing any supports 12 from the first piece 12. In some embodiments the supports 12 can be fully inserted into the first piece 100 for storage. The supports may be stored by pushing the supports further into the corrugated slots of the first piece where they may be full or nearly-fully concealed until a subsequent use. This allows for easy storage of one or more decoys as the entire apparatus disassembles into two-dimensional, flat pieces that acquire little space.

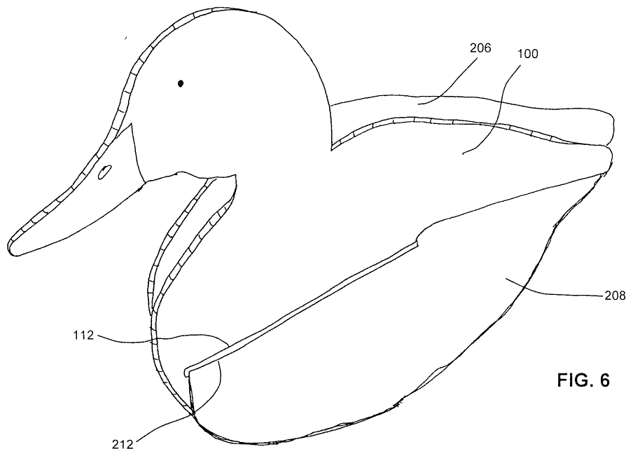

As shown in FIG. 6, the decoy may also be folded for storage without dismantling the second piece 200 from the first piece 100. The wing portions 206, 208 of the second piece can pivot about the horizontal slots 112, 212 so that the second piece vertically aligns with the first piece without being disconnected from the first piece. As such, in this position, the first piece 100 is predominantly parallel to the second piece 200. Therefore, the assembly can still lay flat for storage without the need to disassemble the pieces.

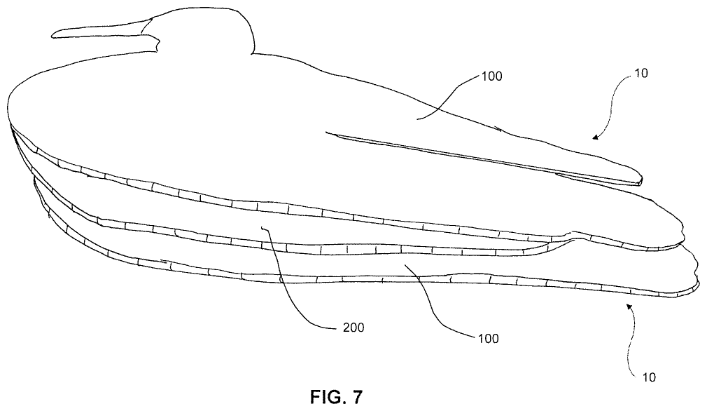

FIG. 7 shows where multiple bird decoys 10 are disassembled and stacked for easy storage taking up minimal space. When disassembled, the first pieces 100 and second pieces 200 of the decoys are predominantly two-dimensional and can be simply stacked upon one another and stored for subsequent uses.

The same assembly and storage procedures may apply to a variety of embodiments of the invention including various species of birds in different positions. For example, embodiments of the invention may include a bird decoy apparatus to represent waterfowl such as Mallard, Black, Pintail and Widgeon Ducks, as well as Canadian, Snow, Speckle Belly, Blues and Bradt Geese. Other types of bird decoys may also be made such as for foraging or predatory birds. Such examples may include Sand Hill Cranes, Crows, Doves, and other varieties. For all types of birds, embodiments of the invention may also include various positions for the decoys. Various types of decoys and various types of positions may be desirable depending on the overall purpose of the decoy whether the purpose be for bird watching, hunting, deterring certain species, or other purposes.

The invention illustratively disclosed herein suitably may be practiced in the absence of any element, part, step, component, or ingredient which is not specifically disclosed herein.

While in the foregoing detailed description this invention has been described in relation to certain preferred embodiments thereof, and many details have been set forth for purposes of illustration, it will be apparent to those skilled in the art that the invention is susceptible to additional embodiments and that certain of the details described herein can be varied considerably without departing from the basic principles of the invention.

What is claimed is:

1. A bird decoy apparatus comprising:
a first piece comprising a blank of like size and shape of a first profile of a bird;
a second piece comprising a blank of like size and shape of a second profile of the bird; and
at least one removable support at least partially inserted into the first piece.

2. The bird decoy apparatus of claim 1 wherein the first profile of the bird comprises a side view of a body of a bird.

3. The bird decoy apparatus of claim 1 wherein the second profile of the bird comprises a top view of a body of a bird, wherein the top view comprises wings of the body of the bird.

4. The bird decoy apparatus of claim 1 wherein the blank of the first piece comprises a head portion, a tail portion, and an edge side surrounding a surface area of the first piece.

5. The bird decoy apparatus of claim 4 wherein the first piece further comprises a slot at the tail portion of the first piece, wherein the slot extends horizontally from the tail portion of the first piece.

6. The bird decoy apparatus of claim 4 wherein the edge side is corrugated.

7. The bird decoy apparatus of claim 6 wherein the corrugated edge side of the first piece is adapted to hold the at least one removable support.

8. The bird decoy apparatus of claim 6 wherein the first piece comprises a first side and a second side, wherein the corrugated edge side is disposed therebetween the first side and the second side.

9. The bird decoy apparatus of claim 8 wherein the first side comprises a photo of the side view of a body of a bird.

10. The bird decoy apparatus of claim 9 wherein the second side mirrors the first side.

11. The bird decoy apparatus of claim 1 wherein the blank of the second piece comprises a right wing portion, a left wing portion, and an edge side surrounding a surface area of the second piece, wherein the right wing portion and the left wing portion extend from a head end of the second piece to a tail end of the second piece.

12. The bird decoy apparatus of claim 11 wherein the second piece further comprises a slot at the head end of the second piece, wherein the slot extends horizontally between the right wing portion and the left wing portion, from the head end of the second piece.

13. The bird decoy apparatus of claim 11 wherein the edge side is corrugated.

14. The bird decoy apparatus of claim 13 wherein the second piece comprises a first side and a second side, wherein the corrugated edge side is disposed therebetween the first side and the second side.

15. The bird decoy apparatus of claim 14 wherein the first side comprises a photo of the top view of a body of a bird.

16. The bird decoy apparatus of claim 15 wherein the second side mirrors the first side.

17. The bird decoy apparatus of claim 12 wherein the slot of the first piece is adapted to accept the second piece at the horizontal slot of the second piece.

18. The bird decoy apparatus of claim 17 wherein the second piece is perpendicular to the first piece.

19. The bird decoy apparatus of claim 17 wherein the second piece is parallel to the first piece.

20. A bird decoy apparatus comprising:
a first piece of like size and shape of a side profile of a bird, wherein the first piece comprises tail portion and a head portion;
a horizontal slot extending from the tail portion of the first piece;
a second piece of like size and shape of a top profile of the bird, wherein the second piece comprises a right wing portion and a left wing portion;
a horizontal slot extending between the right wing portion and the left wing portion of the second piece, wherein the second piece is adapted to connect to the first piece through the horizontal slots; and
at least one removable support at least partially inserted into the first piece.
